(19) United States
(12) Patent Application Publication
(10) Pub. No.: US 2004/0082747 A1
(43) Pub. Date: Apr. 29, 2004

(54) Continuous process for the preparation of absorbable monofilament fibers of homopolymers and random copolymers and the use thereof

(76) Inventor: Amy T. Jonn, Raleigh, NC (US)

Correspondence Address: Amy Jonn, 2308 Wakefield Plantation Dr., Raleigh, NC, 27614, US

(21) Appl. No.: 10/425,060

(22) Filed: Apr. 28, 2003

Related U.S. Application Data
(60) Provisional application No. 60/376,792, filed on May 1, 2002.

(51) Int. Cl. C08F 32/00; B29C 47/60

(52) U.S. Cl. 526/308; 526/317.1; 526/319; 526/313; 264/211.22

(57) ABSTRACT

A process for the preparation of absorbable homopolymers or random copolymers and their processing into monofilament fibers is disclosed. The process comprises a reactive extrusion step where a cyclic monomer or a mixture of cyclic monomers and other additives are polymerized to form absorbable homopolymer or copolymer compositions, which are then extruded continuously and spun into monofilament fibers using regular fiber spinning and drawing techniques.

This invention describes a continuous process for the preparation of monofilament fibers of absorbable homopolymers and random copolymers and the use thereof.

Absorbable polymeric materials, especially polyesters based on hydroxy-carboxylic acids, have been used increasingly in surgical, pharmaceutical, medical and other industrial fields. Devices made form these materials for surgical, pharmaceutical or medical use include sutures, clips, clamps, anchors, matrixes for delivering pharmaceutical agents and support for tissue engineering.

Processes for the preparation of above-mentioned devices are well known in the art. Absorbable polymers are usually synthesized in relatively small quantities by a process known as batch operation. These materials are then processed to desired articles with various shapes or sizes, such as spinning into monofilament fibers. Finally, medical devices, such as monofilament sutures, are manufactured from these processed articles. There are several essential disadvantages in this manufacturing process. First of all, the batch polymerizations result into variations among the batches of the materials, which can cause tremendous difficulties in following steps of processing, such as fiber spinning, and consequently, poor control of the quality of the products. Secondly, the batch reactions require extended processing time, including preparing each batch of polymerization reaction, cleaning the reactor afterwards, post-treating the polymers and extensive testing necessary for the quality controls. The batch fiber spinning is also very time-consuming, mostly in preparation work, fine-tuning the spinning parameters for each batch of the materials and cleaning the extruder. Thirdly, fiber production yield is usually low as the result of all these steps of materials handling processes. And finally, the process of absorbable polymers into desired articles usually requires a second heat treatment, e.g. fiber spinning, where extreme care has to be taken because these absorbable polymers are highly sensitive to environmental moisture for degradation. Even under carefully selected conditions, some degrees of thermal degradation are still unavoidable. It is not uncommon that these absorbable polymers loose 20% of their original viscosity after the thermal processing. Although some efforts of preparing absorbable polymers in a continuous manner have been attempted, a complete continuous process for the preparation of processed articles, such as absorbable monofilament fibers, directly from a continuous polymerization extruder would be much more desirable as outlined by the advantages mentioned above.

The objective of this invention is to provide a continuous process for preparing absorbable homopolymers or random copolymers and processing them directly into desired articles, such as monofilament fibers, for manufacturing devices useful in surgical, medical, pharmaceutical and other industrial fields. The continuous process eliminates the middle steps of all materials handling processes and the analytical testing of a conventional batch process.

The continuous process according to the invention is characterized in that continuous polymerization is conducted in an extruder by continuous feed of mixtures of monomers, catalysts, initiators and if appropriate, any other auxiliary agents, such as plasticizers, coloring agents; the extruded absorbable polymers are then directly processed into monofilament fibers in a continuous manner.

According to the invention, the extruder, single or twin, having an additional and venting ports, coupled with a melt pump if desired, is used as both the polymerization reactor and the fiber spinning tool. The venting ports are designed at various stages of the polymerization to remove unreacted monomers and volatiles if necessary. Other spinning tools comprise a cooling bath and temperature-controlled godets and ovens for stretching and relaxation of the fibers and a winder for collecting processed monofilament fibers.

According to the invention, the feed system of the reaction mixtures comprises an additional hopper in which the monomers, catalysts and other auxiliary agents are homogeneously mixed. The reaction mixtures are charged to the extruder via a conveyor system. Heated hoppers can also be used if melt reaction mixtures are required.

According to the invention, the feed system, the extruder and the melt pump comprise devices under which an inert atmosphere is maintained using nitrogen or argon for carrying out the polymerization in the absence of moisture.

According to the invention, the temperature control elements on both the extruder and the spinning tools are critical for achieving optimal results of spun monofilament fibers. The rotation speeds of the extruder and the melt pump are set to achieve proper dwell time of the reaction mixture for desirable conversion and to control monofilament fibers output.

According to the invention, a single monomer can be charged to produce homopolymers or mixtures of monomers for random copolymers. In another embodiment, preformed polymers or oligomers can also be used with additional monomers to prepare copolymers.

The continuous process according to the invention produces absorbable monofilament fibers of homopolymers or random copolymers prepared with, but not limited to, any one or the combination of the following monomers: glyolide, L-lactide, D-lactide, trimethylene carbonate, caprolactone and dioxanone. Suitable catalysts are known in the art, tin chloride or tin chloride hydrate and stannous octoate being preferred. Initiators are also known in the art, alkyl alcohols, hydorxy carboxylic acids, alkylene diols being preferred. Coloring agents are also known in the art, D&C Violet #2 and D&C Green #6 dyes being preferred.

In contrast to batch operation of preparing absorbable polymers and then spinning into fibers, the monofilament fibers produced according to the invention have very consistent chemical, physical and mechanical properties throughout the manufacturing process as the result of the continuous operation. Furthermore, the continuously produced absorbable polymers do not undergo a second thermal treatment in contrast to the batch operation, where polymers have to be melt completely before being spun, and the monofilament fibers produced according to the invention have higher viscosity and better mechanical properties.

The production yield of the monofilament fibers processed according to the invention is very high. Once the parameters of the continuous process are set, the production of the monofilament fibers can be continued without interruption. Depending on the size of the feeder of the reaction mixtures, the fiber production yield can be as high as over 95%. Once the addition of the reaction mixture in one feeder is completed, a new one can be easily switched-on.

The continuous process according to the invention eliminates all cumbersome preparation and cleaning work associated with the batch operation. Furthermore, some of very costly analytical works are also eliminated and the efficiency is therefore greatly improved. The savings in time and cost of the continuous process of the invention are easily seen by the people skilled in the art.

The invention further relates to the use of the absorbable monofilament fibers prepared by the continuous process for the manufacturing of surgical devices. The representative examples are listed hereinafter, but not limited to, sutures, meshes, devices for osteosynthesis, supports for pharmaceutical agents, bone substitute materials, reinforced bone pins, screws, clamps and plates, vascular implants, vertebral discs, burn and medical dressings, medical gauze, cloth, felt, sponge, artery grafts, tubes for nerve regeneration and absorbable stents.

### EXAMPLE 1

Continuous preparation of monofilaments of poly(dioxanone) A mixture of 5.0 kg of dioxanone and a solution of 10.0 g of lauryl alcohol, 9.0 g of D&C Violet No.2 dye and 1.6 g of tin chloride dihydrate in 150 ml of tetrahydrafuran was placed in an additional hopper in a homogeneous manner. After vacuum drying to remove the solvent, the reaction mixture was purged with nitrogen for 60 minutes with constant shaking. The mixture was then fed continuously into the additional port of a twin extruder having four heating zones under the protection of nitrogen. A melt pump connected to the extruder had a heatable vertical single-hole spinneret with diameter of 1.0 mm. The temperature settings are listed in the following table:

| | | | | | Melt | |
|---|---|---|---|---|---|---|
| Add. Port | Zone 1 | Zone 2 | Zone 3 | Zone 4 | pump | Die |
| Cold | 80° C. | 100° C. | 115° C. | 115° C. | 110° | 110° C. |
| water | | | | | | |

The rotational speed of the extruder was maintained at 20 revolutions per minutes and the monofilament so obtained was orientated by stretching of a total of 6.6× in three stages over a group of three heated ovens and godets. The fiber processing condition is summarized in the table below:

| | Oven 1 | Oven 2 | Oven 3 |
|---|---|---|---|
| Temperature | 60° C. | 55° C. | 40° C. |
| Draw | 4x | 1.5x | 1.1x |

The oriented monofilament was next annealed by placing the spool with the monofilament in an oven heated at 75° C. under vacuum for 12 hours. The mechanical properties of the monofilament are as follows:

Tensile strength, 79.5 kpsi:

Knot strength, 56.0 kpsi

Percent enlongation: 45

Young's modulus, 205.0 kpsi:

### EXAMPLE 2

Continuous Preparation of Monofilament Fibers of Poly(72% Glycolide/28% Caprolactone)

A mixture of 3.6 kg of glycolide and 1.4 kg of caprolactone and a solution of 10.0 g of diethylene glycol, 9.0 g of D&C Violet No.2 dye and 1.5 g of tin chloride dihydrate was placed in a heated additional hopper in a homogeneous manner. The mixture was then fed continuously into the additional port of a twin extruder having four heating zones under the protection of nitrogen. A melt pump connected to the extruder had a heatable vertical single-hole spinneret of with diameter of 1.0 mm. The temperature settings are listed in the following table:

| | | | | | Melt | |
|---|---|---|---|---|---|---|
| Add. Port | Zone 1 | Zone 2 | Zone 3 | Zone 4 | pump | Die |
| | 165° C. | 220° C. | 225° C. | 210° C. | 200° | 185° C. |

The rotational speed of the extruder was maintained at 20 revolutions per minutes and the monofilament so obtained was orientated by stretching of a total 6.6×in three stages over a group of three heated ovens and godets. The fiber processing condition is summarized in the table below:

| | Oven 1 | Oven 2 | Oven 3 |
|---|---|---|---|
| Temperature | 60° C. | 75° C. | 65° C. |
| Draw | 4x | 1.5x | 1.1x |

The oriented monofilament was next annealed by placing the spool with the monofilament in an oven heated at 65° C. under vacuum for 12 hours. The mechanical properties of the monofilament are as follows:

Tensile strength, 72.0 kpsi:

Knot strength, kpsi: 48.0 kpsi

Percent enlongation: 44.0

Young's modulus, 150.0 kpsi:

What is claimed is:

1. A continuous process for the preparation of absorbable monofilament fibers, wherein the polymerization is conducted in an extruder with temperature controls and the extruded absorbable homopolymers or random copolymers are directly processed into monofilament fibers.

2. A preparation process according to claim 1, wherein a single monomer or mixture of monomers or preformed polymers can be used to produce absorbable homopolymers or random copolymers.

3. A preparation process according to claim 2, wherein said monomers are cyclic monomers, comprising cyclic alpha-hydroxy-carboxlic acids, cyclic alkyl esters, cyclic alkyl carbonates and cyclic ester-ethers.

4. Surgical/medical devices manufactured from the absorbable monofilament fibers of claim 1.
